(19) United States
(12) Patent Application Publication
(10) Pub. No.: US 2006/0206934 A1
(43) Pub. Date: Sep. 14, 2006

(54) DHCP client impersonation for VPN tunnels

(75) Inventor: Sergio Ammirata, Coral Springs, FL (US)

Correspondence Address: RUBEN ALCOBA, ESQ., 3399 NE 72 AVENUE, SUITE211, MIAMI, FL, 33122, US

(73) Assignee: Wialan Technologies, INC

(21) Appl. No.: 11/076,280

(22) Filed: Mar. 9, 2005

(51) Int. Cl. G06F 15/16

(52) U.S. Cl. 726/15

(57) ABSTRACT

A network based method that enhances the handshake between clients and virtual private network (VPN) servers so that the internet protocol (IP) address assignment of client tunnels is done by existing dynamic host configuration protocol (DHCP) servers instead of being done by the VPN servers.

### BACKGROUND

When configuring a virtual private network (VPN) server it is always necessary to enter many configuration parameters regarding client tunnels. Such configuration parameters consist of encryption protocols, end point internet protocol (IP) addresses, shared keys, etc. Assigning an IP address pool that will be used to give out IP addresses to connecting clients is one of the most complicated and time consuming parameters when configuring the VPN server.

The reason that the assigning of an IP address pool to a VPN server is complicated and time consuming is because an IP address pool can't overlap with existing IP addresses on the network and can't overlap with IP addresses that may be assignable by dynamic host configuration protocol (DHCP) servers. It is the responsibility of the network administrator to allocate separate IP address ranges for the VPN servers and manage these address ranges as exceptions to the normal DHCP IP address configuration scheme.

In the computer network industry, it is known that DHCP servers are designed to manage and dispatch IP addresses to connecting clients. Network administrators pre-configure DHCP servers of networks with the appropriate IP address pools for auto-assignment.

The present inventor, realized that VPN server configuration problems could be solved by eliminating the need to enter and manage the IP address pools. The inventor has enhanced the VPN handshake protocol, so that the VPN server does not need to have an IP address preconfigured. Instead, the VPN impersonates the client and asks for an IP address assignment using the network's existing DHCP server.

### SUMMARY

The present invention is directed to a network based method that enhances the handshake between clients and VPN servers so that the IP address assignment of client tunnels is done by an existing DHCP server instead of the being done by the VPN server. This is accomplished by replacing the current method of IP address allocation within the VPN server with a DHCP request on behalf of the connecting client.

In every VPN server there is always a part of the handshake between the client and the VPN server that consists of extracting and assigning an IP address from the VPN server's configured address pool to the connecting client. In the present invention, this step of assigning an IP address from the VPN server is replaced by the spawning of a new process or thread that will act as a DHCP client on behalf of the connecting client and obtain an IP address for the client that is managed by the DHCP server instead of the VPN server.

In the present invention, the VPN server impersonates the client's computer to the extent that the VPN server sends an IP address request to the DHCP server. The address request is masked so that the DHCP server believes that the request came from the client computer's media access control (MAC) address. Once the IP address is obtained by the VPN server, the VPN server assigns it to the client tunnel and it keeps the DHCP lease open for as long as the tunnel is open. As soon as the tunnel is terminated, the IP address is released using the standard releasing mechanism of DHCP.

The network based method in which a VPN server assigns an IP address to a client comprises the steps of first receiving from the client a request for a virtual private tunnel. After receiving the request, the VPN server and the client negotiate and establish an encryption protocol to communicate. Then the VPN server requests an IP address from the DHCP server. The DHCP server then sends the IP address to the VPN server, the IP address is leased. Then the VPN server establishes a tunnel with the client using the IP address and lease. And lastly, upon the termination of the client-VPN server tunnel, the VPN server releases the IP address to the DHCP server.

It is known in the art that the VPN server device can also run the DHCP server process.

An object of this invention is to eliminate the need to configure and manage IP client addresses on VPN servers.

Another object of this invention is to prevent conflicts that can arise from improper IP address assignment.

### DRAWINGS

A brief understanding of the present invention can be obtained when the following detailed description of an exemplary embodiment is considered in conjunction with the following drawings, in which:

FIG. 1 illustrates the devices used in this method.

### DESCRIPTION

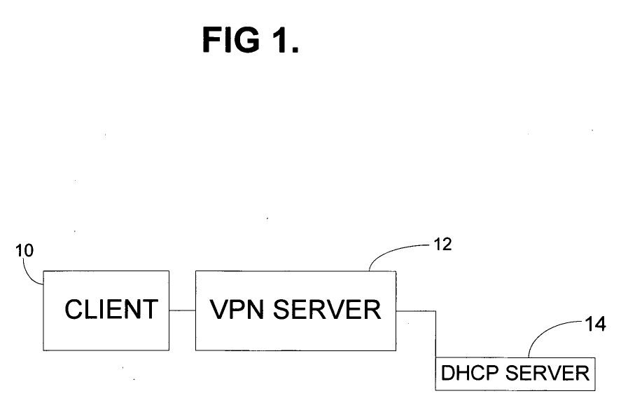

As seen in FIG. 1, an network based method in which a virtual private network server 12 assigns an internet protocol address to a client 10 which comprises the steps of receiving from the client 10 a request for a virtual private network tunnel, then negotiating encryption protocol with the client 10, then establishing an encryption protocol with the client 10, then requesting an internet protocol address from a dynamic host configuration protocol server 14, and then receiving from the dynamic host configuration server 14 an internet protocol address and lease, then establishing a tunnel with the client 10 using the internet protocol address, and lastly releasing the internet protocol address to the dynamic host configuration protocol server 14 after the tunnel is terminated.

In the present invention the VPN server 12 can be any commercial or open source based VPN server, such as IPsec based, SSL based, or PPTP based to name a few. The client 10 can be any device able to connect to the above servers via any wireless or wired connection. The DHCP 14 server can be any commercial or open source DHCP server.

The above method of assigning a specific IP address to a client tunnel eliminates the need of the VPN server 12 having to assign a manual IP address to the client 10. This is accomplished by the VPN server 12 sending a DHCP request to any DHCP server 14 on the network masking the request to seem that it came from the client 10. The request need not be masked, but the important principle of this invention is that the client 10 shall receive a unique IP address that will not duplicate any address being used within the network. The DHCP server 14 upon receiving the requests will assign and lease the VPN server 12 an IP address for the benefit of the client 10. After the client 10 and the VPN server 12 complete negotiations of the encryption method, the VPN server 12 relays the IP address to the client 10.

The present invention has two methods of managing the expiration of the IP address lease. In the first variation, the VPN server 12 will automatically renew the lease prior to the lease expiring. The lease will expire based on a time to live that is defined by the DHCP server 14. In the other variation of this invention, the VPN server 12 will close the tunnel when the IP address lease expires. In either scenario, the VPN server 12 will release the IP address to the DHCP server 14 as soon as the VPN tunnel closes.

It is known in the art that the VPN server device can also run the DHCP server process.

An advantage of this invention is that it eliminates the need to configure and manage IP client tunnel addresses on VPN servers.

Another advantage of this invention is that it prevents conflicts that can arise from improper IP address assignments.

Although the present invention has been described in considerable detail with reference to certain preferred versions thereof, other versions are possible. Therefore the spirit and the scope of the claims should not be limited to the description of the preferred versions contained herein.

What is claimed is:

1. A network based method in which a virtual private network server assigns an internet protocol address to a client tunnel which comprises the steps of:
receiving from the client a request for a virtual private network tunnel;
negotiating encryption protocol with the client;
establishing an encryption protocol with the client;
requesting an internet protocol address from a dynamic host configuration protocol server;
receiving from the dynamic host configuration server an internet protocol address and lease;
establishing a tunnel with the client using the internet protocol address; and
releasing the internet protocol address to the dynamic host configuration protocol server after the tunnel is terminated.

2. The network based method of claim 1, wherein the virtual private network server and the dynamic host configuration protocol server are one and the same.

3. The network based method of claim 2, wherein the releasing step is an automatic closing of the virtual private network tunnel when the internet protocol address lease expires.

4. The network based method of claim 3, wherein in the requesting of the internet protocol address from the dynamic host protocol server, the request is masked to appear to be coming from the client.

5. The network based method of claim 1, wherein the releasing step is an automatic closing of the virtual private network tunnel when the internet protocol address lease expires.

6. The network based method of claim 5, wherein in the requesting of the internet protocol address from the dynamic host protocol server, the request is masked to appear to be coming from the client.

7. The network based method of claim 1, wherein in the requesting of the internet protocol address from the dynamic host protocol server, the request is masked to appear to be coming from the client.

8. The network based method of claim 7, wherein the releasing step is an automatic closing of the virtual private network tunnel when the internet protocol address lease expires.

9. The network based method of claim 8, wherein the virtual private network server and the dynamic host configuration protocol server are one and the same.
